(19) United States
(12) Patent Application Publication
(10) Pub. No.: US 2022/0372241 A1
(43) Pub. Date: Nov. 24, 2022

(54) ECO-FRIENDLY FOAM

(71) Applicant: TSP BIOCHEM CoO., LTD., Incheon (KR)

(72) Inventor: Sung Dae HONG, Incheon (KR)

(21) Appl. No.: 17/772,789

(22) PCT Filed: Oct. 16, 2020
(86) PCT No.: PCT/KR2020/014155

§ 371 Date: Apr. 28, 2022

(30) Foreign Application Priority Data
Oct. 30, 2019 (KR) 10-2019-0136623

(51) Int. Cl. C08J 9/236; C08J 9/00

(52) U.S. Cl. CPC C08J 9/236; C08J 9/0061; C08J 9/0066; C08J 2323/12; C08J 2303/02

(57) ABSTRACT

The present invention relates to an Eco-friendly foam, and more particularly, to an Eco-friendly foam that exhibits excellent foamability, excellent thermal insulation performance, a remarkably small amount of harmful gas emission, and excellent dimensional stability and elasticity.

### BACKGROUND

### 1. Field of the Invention

The present invention relates to an Eco-friendly foam, and more particularly, to an Eco-friendly foam that exhibits excellent foamability, excellent thermal insulation performance, a remarkably small amount of harmful gas emission, and excellent dimensional stability and elasticity.

### 2. Discussion of Related Art

Conventionally, a foam which uses synthetic resin as a raw material is widely used as a buffering material, a heat retaining material, or a heat insulating material. However, in the case of a foam made of only synthetic resin, not only when the harmful foaming gas is used during production but also when it is discarded after use, there is a problem of causing environmental pollution because it is not easily decomposed by microorganisms present in nature, and a large amount of harmful gases such as dioxins are released after incineration, causing global warming and environmental problems.

In addition, when incinerated, there is a problem in that the incinerator is easily damaged because the amount of heat generated is high. In addition, polystyrene-based plastic foams are specifically pointed out as having the problem of generating environmental hormones in addition to the above problems.

Accordingly, in recent years, in order to solve the above-mentioned problems, development is in progress to manufacture a foam through an Eco-friendly material that is easy to biodegrade. However, in the case of a foam manufactured using a conventional Eco-friendly material that is easily biodegradable, there has been a problem of not being able to simultaneously exhibit the effects of excellent foamability, excellent thermal insulation performance, a significantly less harmful gas emission amount, and excellent dimensional stability and elasticity.

Accordingly, there is an urgent need to develop a foam that exhibits excellent foamability, excellent thermal insulation performance, a remarkably small amount of harmful gas emission, and excellent dimensional stability and elastic force.

### SUMMARY OF THE INVENTION

The present invention has been devised to solve the above problems, and it is an object of the present invention to provide an Eco-friendly foam that exhibits excellent foamability, excellent thermal insulation performance, a remarkably small amount of harmful gas emission, and excellent dimensional stability and elasticity.

In order to solve the above problems, the present invention provides an Eco-friendly foam formed by including 35 to 155 parts by weight of powdered polypropylene based on 100 parts by weight of starch.

According to an embodiment of the present invention, the starch may have an average particle diameter of 7 to 53 μm.

In addition, the polypropylene may have an average particle diameter of 1000 μm or less.

In addition, the Eco-friendly foam may have a density of 20 to 85 kg/m³.

In addition, the thermal conductivity measured by the following Measurement Method 1 may be 0.05 W/mK or less.

[Measurement Method 1]

The thermal conductivity is measured under the condition of a temperature of 20° C. according to KS L 9016:2010 (plate heat flow meter method).

In addition, the dynamic modulus of elasticity may be 3.8 to 27.5 MN/m³ and the loss coefficient may be 0.15 to 0.35, and the dynamic modulus of elasticity after heating may be 5.8 to 39 MN/m³ and the loss coefficient after heating may be 0.15 to 0.35, as measured by the following Measurement Method 2.

[Measurement Method 2]

Under conditions of 22° C. and a relative humidity of 50%, the dynamic modulus of elasticity and loss coefficient are measured according to KS F 2862:2003, and the dynamic modulus of elasticity and loss coefficient after heating are measured according to KS M ISO 4898:2013.

In addition, a ratio of the dynamic modulus of elasticity and the dynamic modulus of elasticity after heating may be 1:1.28 to 1.65.

In addition, the length change rate in the longitudinal direction of the long axis may be 0.6% or less, and the length change rate in the longitudinal direction of the short axis may be 0.4% or less, as measured by the following Measurement Method 3.

[Measurement Method 3]

The length change rates are measured under the conditions of a temperature of 70° C. and 48 hours according to KS M ISO 4898:2013.

In addition, the absorbency measured by the Measurement Method 3 may be 9 to 18%.

In addition, the volatile organic compound (VOC) content may be 0.03 wt % or less, as measured by the following Measurement Method 4.

[Measurement Method 4]

The volatile organic compound content is measured according to KS M ISO 11892-2:2014.

In addition, a total volatile organic compound (TVOC) emission amount may be 0.005 mg/(m²·hr) or less, and a toluene emission amount may be 0.00003 mg/(m²·hr) or less, and a formaldehyde emission amount may be 0.002 mg/(m²·hr) or less, as measured by the following Measurement Method 5.

[Measurement Method 5]

The total volatile organic compound emission amount is measured according to ES 02131.1c, the toluene emission amount is measured according to ES 02601.1b, and the formaldehyde emission amount is measured according to ES 02602.1b.

In addition, one or more inorganic minerals selected from the group consisting of titanium (Ti), silicon (Si), and magnesium (Mg) may be further included, based on 100 parts by weight of the starch.

### Effects of the Invention

The Eco-friendly foam of the present invention has excellent foamability, excellent thermal insulation performance, a remarkably small amount of harmful gas emission, and excellent dimensional stability and elasticity.

### DETAILED DESCRIPTION OF EXEMPLARY EMBODIMENTS

Hereinafter, embodiments of the present invention will be described in detail so as to be easily carried out by those skilled in the art. The present invention may be embodied in many different forms and is not limited to the embodiments set forth herein.

The Eco-friendly foam according to an embodiment of the present invention is formed by including starch and powdered polypropylene.

First, the starch will be described.

The starch can be used without limitation as long as it is a starch that allows uniform, stable foaming during the production of an environmentally friendly foam and can be conventionally used in the art, and preferably at least one selected from the group consisting of natural regenerated starch and processed starch for animal feed can be employed in terms of applying a raw material that is environmentally friendly.

In addition, the starch may have an average particle diameter of 7 to 53 μm, preferably 10 to 50 μm. When the average particle diameter of the starch is less than 7 μm, the phenomenon of agglomeration during process input may frequently occur, a uniform foam cannot be made for use as a product, a uniform elastic force cannot be secured, which degrades the function of the foam, and when the average particle diameter exceeds 53 μm, dimensional stability and thermal insulation may be degraded.

Next, the polypropylene will be described.

The polypropylene serves as a binder, and is powdered polypropylene.

The polypropylene may have an average particle diameter of 1000 μm or less, preferably 950 μm or less. When the average particle diameter of the polypropylene exceeds 1000 μm, it is not possible to ensure uniform flowability of the polymer, and foamability and thermal insulation may be degraded.

In addition, the powdered polypropylene may be included in an amount of 35 to 155 parts by weight, preferably 40 to 150 parts by weight, based on 100 parts by weight of the starch. When the amount of polypropylene is less than 35 parts by weight based on 100 parts by weight of starch, uniform and stable foaming is not easy, dimensional stability and elasticity may be degraded, and when polypropylene exceeds 155 parts by weight, foamability and thermal insulation may be degraded.

Meanwhile, the Eco-friendly foam according to the present invention may further include an inorganic mineral.

The inorganic mineral performs a function of improving processability, and any inorganic mineral commonly used in the art may be used without limitation, and preferably may include one or more selected from the group consisting of titanium (Ti), silicon (Si) and magnesium (Mg).

In addition, the inorganic mineral may be further included in an amount of 0.01 to 10 parts by weight, preferably 0.05 to 5 parts by weight, based on 100 parts by weight of the starch, but is not limited thereto.

The Eco-friendly foam according to the present invention may have a density of 20 to 85 kg/m³, and preferably a density of 20 to 80 kg/m³. When the density of the Eco-friendly foam is less than 20 kg/m³, dimensional stability and thermal insulation may be degraded, and when the density exceeds 85 kg/m³, the dimensional stability and thermal insulation may be degraded.

In addition, the Eco-friendly foam according to the present invention may have a thermal conductivity of 0.05 W/mK or less, preferably 0.04 W/mK or less, more preferably 0.035 W/mK or less, as measured by the following Measurement Method 1.

[Measurement Method 1]

The thermal conductivity is measured under the condition of a temperature of 20° C. according to KS L 9016:2010 (plate heat flow meter method).

It can be determined that high thermal conductivity means that thermal insulation is not good.

When the thermal conductivity measured by the Measurement Method 1 exceeds 0.05 W/mK, thermal insulation may be degraded.

In addition, the Eco-friendly foam according to the present invention may have a dynamic modulus of elasticity of 3.8 to 27.5 MN/m³ and a loss coefficient of 0.15 to 0.35, preferably a dynamic modulus of elasticity of 4.2 to 26.85 MN/m³ and a loss coefficient of 0.2 to 0.3, as measured by the following Measurement Method 2, and a dynamic modulus of elasticity after heating may be 5.8 to 39 MN/m and a loss coefficient after heating may 0.15 to 0.35, preferably a dynamic modulus of elasticity after heating may be 6.3 to 38.5 MN/m and a loss coefficient after heating may be 0.2 to 0.3.

[Measurement Method 2]

under conditions of 22° C. and a relative humidity of 50%, the dynamic modulus of elasticity and loss coefficient are measured according to KS F 2862:2003, and the dynamic modulus of elasticity and loss coefficient after heating are measured according to KS M ISO 4898:2013.

At this time, a low dynamic modulus of elasticity indicates that the elastic force is not good, and a high dynamic modulus of elasticity means that the elastic force is excellent, but dimensional stability, foamability and thermal insulation are not good.

When the dynamic modulus of elasticity is less than 3.8 MN/m³ or the dynamic modulus of elasticity after heating is less than 5.8 MN/m³, the elastic force may be poor, and when the dynamic modulus of elasticity exceeds 27.5 MN/m³ or the dynamic modulus of elasticity after heating is exceeds 39 MN/m³, dimensional stability, foamability and thermal insulation may be poor.

Meanwhile, the Eco-friendly foam according to the present invention satisfies the ratio of the dynamic modulus of elasticity and the dynamic modulus of elasticity after heating, and the ratio of the dynamic modulus of elasticity and the dynamic modulus of elasticity after heating may be 1:1.28 to 1.65, preferably 1:1.34 to 1.62. When the ratio range of the dynamic modulus of elasticity and the dynamic modulus of elasticity after heating is not satisfied, elasticity, dimensional stability, foamability, and thermal insulation may be degraded.

In addition, the Eco-friendly foam according to the present invention may have a length change rate in the longitudinal direction of the long axis of 0.6%, preferably a length change rate in the longitudinal direction of the long axis of 0.55% or less, as measured by the following Measurement Method 3, and the length change rate in the longitudinal direction of the short axis may be 0.4% or less, preferably, the length change rate in the longitudinal direction of the short axis may be 0.35% or less.

[Measurement Method 3]

the length change rates are measured under the conditions of a temperature of 70° C. and 48 hours according to KS M ISO 4898:2013.

In this case, a high length change rate indicates poor dimensional stability. When the length change rate in the longitudinal direction of the long axis exceeds 0.6%, or the length change rate in the longitudinal direction of the short axis exceeds 0.4%, dimensional stability may be degraded and foamability may be poor.

Meanwhile, the terms ‘long axis’ and ‘short axis,’ when the foam has a quadrangular shape, respectively, refers to a long side and a short side, or a long side and the short side perpendicular to the long side, and when it has an amorphous shape such as a pellet shape, the axis showing the longest length in the cross section is defined as the long axis, and the axis perpendicular to and showing the shortest length in the cross-section is defined as the short axis.

In addition, the Eco-friendly foam according to the present invention may have an absorbency of 9 to 18%, preferably 9.5 to 17.3%, as measured by the Measurement Method 3 above. When the absorbency is less than 9%, the elastic force may be degraded, and when it exceeds 18%, thermal insulation and dimensional stability may be degraded.

In addition, the Eco-friendly foam according to the present invention may have a volatile organic compound (VOC) content of 0.03% by weight or less, preferably 0.02% by weight or less, as measured by the following Measurement Method 4.

[Measurement Method 4]

The volatile organic compound content is measured according to KS M ISO 11892-2:2014.

In addition, the Eco-friendly foam according to the present invention may have a total volatile organic compound (TVOC) emission amount of 0.005 mg/(m²·hr) or less, preferably 0.0035 mg/(m²·hr) or less, and a toluene emission amount may be 0.00003 mg/(m²·hr) or less, and a formaldehyde emission amount may be 0.002 mg/(m²·hr) or less, preferably 0.0015 mg/(m²·hr) or less, as measured by the following Measurement Method 5.

[Measurement Method 5]

The total volatile organic compound emission amount is measured according to ES 02131.1c, the toluene emission amount is measured according to ES 02601.1b, and the formaldehyde emission amount is measured according to ES 02602.1b.

As the volatile organic compound (VOC) content, total volatile organic compound (TVOC) emission amount, the toluene emission amount, and the formaldehyde emission amount ranges are all satisfied, the effect of excellent foamability, excellent thermal insulation performance, low dimensional stability, and an excellent elastic force can be simultaneously exhibited, and as the amount of harmful gas emission is remarkably small, even an Eco-friendly effect can be expressed.

The Eco-friendly foam of the present invention has excellent foamability, excellent thermal insulation performance, a remarkably small amount of harmful gas emission, and excellent dimensional stability and elasticity.

### DETAILED DESCRIPTION OF EXEMPLARY EMBODIMENTS

Hereinafter, the present invention will be described in more detail through examples, but the following examples do not limit the scope of the present invention, which should be construed to aid understanding of the present invention.

### Example 1

Based on 100 parts by weight of starch having an average particle diameter of 15.29 μm, 95 parts by weight of powdered polypropylene having an average particle diameter of 500 μm and 0.5 parts by weight of magnesium silica hydroxide as an inorganic mineral were added, then stirred at 23° C. for 45 minutes, then subjected to extrusion and foaming under the temperature conditions of cylinder 1 75° C., cylinder 2 110° C., cylinder 3 150° C., cylinder 4 175° C., cylinder 5 180° C. through an extrusion foaming machine having five separate compressor cylinders and aged for 3 hours to prepare an Eco-friendly foam. The density of the foam prepared was 50.3 kg/m³.

### Examples 2 to 15

Eco-friendly foams as shown in Tables 1 to 3 were prepared in the same manner as in Example 1 except that the average particle diameter of starch, the average particle diameter and content of polypropylene, and the density of the foam were changed.

### Experimental Example

The following physical properties were evaluated for the foams prepared in Examples and Comparative Examples, and are shown in Tables 1 to 3 below.

1. Thermal Conductivity Measurement

For the foams prepared according to Examples and Comparative Examples, the thermal conductivity was measured under the condition of a temperature of 20° C. according to KS L 9016:2010 (plate heat flow meter method).

2. Dynamic Modulus of Elasticity and Loss Modulus Measurement

For the foams prepared according to Examples and Comparative Examples, dynamic modulus of elasticity and loss coefficient were measured under conditions of 22° C. and 50% relative humidity according to KS F 2862:2003.

3. Measurement of Dynamic Modulus of Elasticity after Heating and Loss Coefficient after Heating

For the foams prepared according to Examples and Comparative Examples, the dynamic modulus of elasticity after heating and the loss coefficient after heating were measured under conditions of 22° C. and 50% relative humidity according to KS M ISO 4898:2013.

4. Dimensional Stability Evaluation

For the foams prepared according to Examples and Comparative Examples, according to KS M ISO 4898:2013, the rates of change in length in the longitudinal direction of the long and short axes were measured under the conditions of a temperature of 70° C. and 48 hours to evaluate dimensional stability.

5. Absorbency Measurement

For the foams prepared according to Examples and Comparative Examples, absorbency was measured according to KS M ISO 4898:2013.

6. Measurement of Volatile Organic Compound (VOC) Content

For the foams prepared according to Examples and Comparative Examples, the volatile organic compound content was measured according to KS M ISO 11892-2:2014.

7. Assessment of Amount of Air Pollutant Emission

For the foams prepared according to Examples and Comparative Examples, the total volatile organic compound emission amount was measured according to ES 02131.1c, the toluene emission amount is measured according to ES 02601.1b, and the formaldehyde emission amount is measured according to ES 02602.1b.

8. Processability Evaluation

For the foams manufactured according to Examples and Comparative Examples, to evaluate processability, when there is no abnormality during manufacture, it is indicated by ◯, and when any abnormality such as poor foaming or over-foaming occurs in the process, it is indicated by x.

TABLE 1

| | | Example | Example | Example | Example | Example |
|---|---|---|---|---|---|---|
| Classification | | 1 | 2 | 3 | 4 | 5 |
| Starch | Average | 15.29 | 4 | 10.52 | 49.74 | 60 |
| | particle size | | | | | |
| | (μm) | | | | | |
| Polypropylene | Average | 500 | 500 | 500 | 500 | 500 |
| | particle size | | | | | |
| | (μm) | | | | | |
| | Content (parts | 95 | 95 | 95 | 95 | 95 |
| | by weight) | | | | | |
| Foam | Density | 50.3 | 76.9 | 55.6 | 48.1 | 47.8 |
| | (kg/m³) | | | | | |

| | | | | | |
|---|---|---|---|---|---|
| Thermal conductivity (W/mK) | 0.035 | 0.035 | 0.035 | 0.04 | 0.08 |
| Dynamic modulus of elasticity | 6.3 | 6.6 | 6.4 | 13.7 | 29.6 |
| (MN/m³) | | | | | |
| Loss coefficient (MN/m³) | 0.3 | 0.3 | 0.3 | 0.3 | 0.5 |
| Dynamic modulus of elasticity | 10.11 | 11.49 | 10.02 | 20.8 | 43.3 |
| after heating (MN/m³) | | | | | |
| Loss coefficient after heating | 0.3 | 0.3 | 0.3 | 0.3 | 0.5 |
| (MN/m³) | | | | | |
| Long-axis length change rate | 0.16 | 0.9 | 0.41 | 0.18 | 0.16 |
| (%) | | | | | |
| Short-axis length change rate | 0.33 | 0.7 | 0.34 | 0.33 | 0.33 |
| (%) | | | | | |
| Absorbency (%) | 15.2 | 21.1 | 16.2 | 15.5 | 15.3 |
| Volatile Organic Compound | 0.02 | 0.02 | 0.02 | 0.02 | 0.02 |
| content (VOC) (% by weight) | | | | | |
| Total Volatile Organic | 0.003 | 0.003 | 0.003 | 0.003 | 0.003 |
| Compound (TVOC) emission | | | | | |
| amount (mg/(m² · hr)) | | | | | |
| Toluene emission amount | 0.00003 | 0.00003 | 0.00003 | 0.00003 | 0.00003 |
| (mg/(m² · hr)) | or less | or less | or less | or less | or less |
| Formaldehyde emission | 0.001 | 0.001 | 0.001 | 0.001 | 0.001 |
| amount (mg/(m² · hr)) | | | | | |
| Processability | ∘ | x | ∘ | ∘ | ∘ |

TABLE 2

| | | Example | Example | Example | Example | Example |
|---|---|---|---|---|---|---|
| Classification | | 6 | 7 | 8 | 9 | 10 |
| Starch | Average | 15.29 | 15.29 | 15.29 | 15.29 | 15.29 |
| | particle size | | | | | |
| | (μm) | | | | | |
| Polypropylene | Average | 950 | 1100 | 500 | 500 | 500 |
| | particle size | | | | | |
| | (μm) | | | | | |
| | Content (parts | 95 | 95 | 25 | 40 | 150 |
| | by weight) | | | | | |
| Foam | Density | 47.6 | 75.3 | 56.2 | 54.4 | 59.9 |
| | (kg/m³) | | | | | |

| | | | | | |
|---|---|---|---|---|---|
| Thermal conductivity (W/mK) | 0.04 | 0.075 | 0.035 | 0.035 | 0.039 |
| Dynamic modulus of elasticity | 6.8 | 6.7 | 3.5 | 6.1 | 7.6 |
| (MN/m³) | | | | | |
| Loss coefficient (MN/m³) | 0.3 | 0.3 | 0.2 | 0.3 | 0.3 |
| Dynamic modulus of elasticity | 10.5 | 10.2 | 4.4 | 9.6 | 11.7 |
| after heating (MN/m³) | | | | | |
| Loss coefficient After heating | 0.3 | 0.3 | 0.2 | 0.3 | 0.3 |
| (MN/m³) | | | | | |
| Long-axis length change rate | 0.36 | 0.29 | 0.9 | 0.3 | 0.28 |
| (%) | | | | | |
| Short-axis length change rate | 0.32 | 0.30 | 0.6 | 0.35 | 0.3 |
| (%) | | | | | |
| Absorbency (%) | 15.6 | 15.1 | 20.8 | 16.0 | 15.4 |
| Volatile Organic Compound | 0.02 | 0.02 | 0.02 | 0.02 | 0.02 |
| (VOC) content (% by weight) | | | | | |
| Total Volatile Organic | 0.003 | 0.003 | 0.003 | 0.003 | 0.003 |
| Compound (TVOC) amount | | | | | |
| (mg/(m² · hr)) | | | | | |
| Toluene emission amount | 0.00003 | 0.00003 | 0.00003 | 0.00003 | 0.00003 |
| (mg/(m² · hr)) | or less | or less | or less | or less | or less |
| Formaldehyde emission | 0.001 | 0.001 | 0.001 | 0.001 | 0.001 |
| amount (mg/(m² · hr)) | | | | | |
| Processability | ∘ | x | x | ∘ | ∘ |

TABLE 3

| | | Example | Example | Example | Example | Example |
|---|---|---|---|---|---|---|
| Classification | | 11 | 12 | 13 | 14 | 15 |
| Starch | Average | 15.29 | 15.29 | 15.29 | 15.29 | 15.29 |
| | particle size | | | | | |
| | (μm) | | | | | |
| Polypropylene | Average | 500 | 500 | 500 | 500 | 500 |
| | particle size | | | | | |
| | (μm) | | | | | |
| | Content (parts | 170 | 95 | 95 | 95 | 95 |
| | by weight) | | | | | |
| foam | Density | 77.1 | 15.4 | 22.9 | 80.6 | 91.6 |
| | (kg/m3) | | | | | |

| | | | | | |
|---|---|---|---|---|---|
| Thermal conductivity (W/mK) | 0.11 | 0.13 | 0.036 | 0.037 | 0.16 |
| Dynamic modulus of elasticity | 7.3 | 7.1 | 6.6 | 6.8 | 7.1 |
| (MN/m³) | | | | | |
| Loss coefficient (MN/m³) | 0.3 | 0.3 | 0.3 | 0.3 | 0.3 |
| Dynamic modulus of elasticity | 11.0 | 10.9 | 10.2 | 10.7 | 11.2 |
| after heating (MN/m³) | | | | | |
| Loss coefficient After heating | 0.3 | 0.3 | 0.3 | 0.3 | 0.3 |
| (MN/m³) | | | | | |
| Long-axis length change rate | 0.27 | 1.1 | 0.33 | 0.3 | 1.2 |
| (%) | | | | | |
| Short-axis length change rate | 0.31 | 0.8 | 0.2 | 0.21 | 0.7 |
| (%) | | | | | |
| Absorbency (%) | 15.5 | 22.3 | 15.7 | 15.5 | 8.4 |
| Volatile Organic Compound | 0.02 | 0.02 | 0.02 | 0.02 | 0.02 |
| (VOC) content (% by weight) | | | | | |
| Total Volatile Organic | 0.003 | 0.003 | 0.003 | 0.003 | 0.003 |
| Compound (TVOC) amount | | | | | |
| (mg/(m² · hr)) | | | | | |
| Toluene emission amount | 0.00003 | 0.00003 | 0.00003 | 0.00003 | 0.00003 |
| (mg/(m² · hr)) | or less | or less | or less | or less | or less |
| Formaldehyde emission | 0.001 | 0.001 | 0.001 | 0.001 | 0.001 |
| amount (mg/(m² · hr)) | | | | | |
| Processability | x | x | ∘ | ∘ | x |

As can be seen from Tables 1 to 3, It can be confirmed that Examples 1, 3, 4, 6, 9, 10, 13 and 14 satisfy all of the average particle diameter of starch, average particle diameter and content of polypropylene, density of foam, and type of polymer according to the present invention are remarkably excellent in foamability, heat insulating property, elastic force, and dimensional stability as compared with Example 2, 5, 6, 7, 11, 12 and 15 and and Comparative Example 1 in which even one of them is omitted, and exhibit an environmentally friendly effect with a remarkably small amount of harmful gas released.

Although one embodiment of the present invention has been described above, the spirit of the present invention is not limited to the embodiment presented herein, and those skilled in the art, having an understanding of the scope of the invention, will readily suggest other embodiments by addition, alteration, deletion, addition, etc., of components within the same spirit, but they are also intended to fall within the spirit of the present invention.

What is claimed is:

1. An Eco-friendly foam formed by comprising 35 to 155 parts by weight of powdered polypropylene based on 100 parts by weight of starch.

2. The Eco-friendly foam of claim 1, wherein the starch has an average particle diameter of 7 to 53 μm.

3. The Eco-friendly foam of claim 1, wherein the polypropylene has an average particle diameter of 1000 μm or less.

4. The Eco-friendly foam of claim 1, wherein the Eco-friendly foam has a density of 20 to 85 kg/m³.

5. The Eco-friendly foam of claim 1, wherein a thermal conductivity measured by the following Measurement Method 1 is 0.05 W/mK or less:
[Measurement Method 1]
the thermal conductivity is measured under the condition of a temperature of 20° C. according to KS L 9016:2010 (plate heat flow meter method).

6. The Eco-friendly foam of claim 1, wherein as measured by the following Measurement Method 2,
a dynamic modulus of elasticity is 3.8 to 27.5 MN/m³ and a loss coefficient is 0.15 to 0.35, and
a dynamic modulus of elasticity after heating is 5.8 to 39 MN/m³ and a loss coefficient after heating is 0.15 to 0.35:
[Measurement Method 2]
under conditions of 22° C. and a relative humidity of 50%, the dynamic modulus of elasticity and loss coefficient are measured according to KS F 2862:2003, and the dynamic modulus of elasticity after heating and the loss coefficient after heating are measured according to KS M ISO 4898:2013.

7. The Eco-friendly foam of claim 6, wherein a ratio of the dynamic modulus of elasticity to the dynamic modulus of elasticity after heating is 1:1.28 to 1.65.

8. The Eco-friendly foam of claim 1, as measured by the following Measurement Method 3,
a length change rate in a longitudinal direction of a long axis is 0.6% or less, and
a length change rate in a longitudinal direction of a short axis is 0.4% or less:
[Measurement Method 3]
the length change rates are measured under the conditions of a temperature of 70° C. and 48 hours according to KS M ISO 4898:2013.

9. The Eco-friendly foam of claim 8, wherein an absorbency measured by the Measurement Method 3 is 9 to 18%.

10. The Eco-friendly foam of claim 1, wherein a volatile organic compound (VOC) content is 0.03 wt % or less, as measured by the following Measurement Method 4:
[Measurement Method 4]
the volatile organic compound content is measured according to KS M ISO 11892-2:2014.

11. The Eco-friendly foam of claim 1, wherein as measured by the following Measurement Method 5,
a total volatile organic compound (TVOC) emission amount is 0.005 mg/(m²·hr) or less,
a toluene emission amount is 0.00003 mg/(m²·hr) or less, and
a formaldehyde emission amount is 0.002 mg/(m²·hr) or less:
[Measurement Method 5]
the total volatile organic compound emission amount is measured according to ES 02131.1c, the toluene emission amount is measured according to ES 02601.1b, and the formaldehyde emission amount is measured according to ES 02602.1b.

12. The Eco-friendly foam of claim 1, further comprising one or more inorganic minerals selected from the group consisting of titanium (Ti), silicon (Si) and magnesium (Mg) based on 100 parts by weight of the starch.
